(19) United States
(12) Patent Application Publication
(10) Pub. No.: US 2025/0315311 A1
(43) Pub. Date: Oct. 9, 2025

(54) SYSTEM FOR CLOUD SOLUTION MIGRATION AND MANAGEMENT

(71) Applicant: T-Mobile USA, Inc., Bellevue, WA (US)

(72) Inventor: Phi Hoang Nguyen, Lacey, WA (US)

(21) Appl. No.: 19/242,556

(22) Filed: Jun. 18, 2025

Related U.S. Application Data
(63) Continuation-in-part of application No. 18/443,914, filed on Feb. 16, 2024.

(51) Int. Cl. G06F 9/50

(52) U.S. Cl. CPC G06F 9/5044; G06F 9/505; G06F 9/5055

(57) ABSTRACT

The system can receive data, including a specification for a cloud solution, indicating a type of cloud solution and at least one requirement. The system can determine a list of cloud service providers with cloud infrastructure capable of hosting the cloud solution and an ability to satisfy the at least one requirement. The system can rank the cloud service providers based on the capability to host the cloud solution and the ability to satisfy the at least one requirement. The system can select the cloud service provider based on the ranking. The system can generate an implementation procedure based on an Application Programming Interface (API) specification, where the API specification determines a requirement for the cloud solution to be deployed on the cloud infrastructure. The system can deploy, using a large language model (LLM), the cloud solution on the cloud infrastructure in accordance with the implementation procedure.

### CROSS-REFERENCE TO RELATED APPLICATIONS

This application is a continuation-in-part of U.S. patent application Ser. No. 18/443,914, filed Feb. 16, 2024, which is hereby incorporated by reference in its entirety.

### BACKGROUND

Cloud computing is the on-demand availability of computer system resources, especially data storage (cloud storage) and computing power, without direct active management by the user. Large clouds often have functions distributed over multiple locations, each of which is a data center. Cloud computing relies on sharing of resources to achieve coherence and typically uses a pay-as-you-go model, which can help in reducing capital expenses but may also lead to unexpected operating expenses for users.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an embodiment for selecting and implementing a new cloud solution.

FIG. 4 illustrates a flow diagram for selecting a new cloud provider for an existing cloud solution.

FIG. 5 illustrates a block diagram of various features of an embodiment of the system.

FIG. 6 illustrates a flow diagram of an embodiment of a calculator tool.

FIG. 7 illustrates a flow diagram for an embodiment of the recommendation process.

FIG. 8 illustrates a flow diagram of an embodiment of a monitoring hub.

FIG. 9 illustrates a flow diagram of an embodiment for replacing a cloud infrastructure component.

FIG. 10 is a flow diagram illustrating an embodiment of a cloud migration process.

FIG. 11 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system that can seamlessly implement a new cloud solution on the cloud infrastructure of a cloud service provider. In one example, the system receives a specification for a cloud solution. The specification defines a series of parameters for the cloud solution, such as the type of cloud solution and the requirements for the cloud solution. A cloud solution includes a cloud service provider, which refers to an entity that offers on-demand, scalable computing resources over the Internet used to implement a cloud solution. A cloud solution is a computing service hosted on the cloud infrastructure of the cloud service provider over the Internet. A cloud solution can be an infrastructure-as-a-service (IaaS), platform-as-a-service (PaaS), software-as-a-service (SaaS), or function-as-a-service (FaaS). IaaS is a form of cloud computing service that offers on-demand essential computing, storage, and networking resources. PaaS is a complete development and deployment environment in the cloud, with resources that enable you to deliver everything from simple cloud-based applications to sophisticated, cloud-enabled enterprise applications. SaaS allows users to connect to and use cloud-based applications over the Internet—for example, email, calendaring, and productivity tools. FaaS is an event-driven execution model that allows developers to build, run, and manage application packages as functions without maintaining any infrastructure. For example, cloud infrastructure can refer to the hardware components and software used to host the cloud solution.

In one example, the requirements for a cloud system include the ability of the cloud infrastructure to support a threshold amount of user traffic volume or a certain user traffic type. In another example, the requirements for the cloud system can be a provisioning speed or reliability of the cloud infrastructure, the scalability of the cloud solution on the cloud infrastructure, and/or the security protocols, technology, or controls enacted by the cloud service provider. The scalability of the cloud infrastructure refers to the ability to increase or decrease the amount of computing power, storage, or bandwidth resources delivered to the cloud solution.

The disclosed technology solves issues resulting from different cloud service providers that enact different criteria to deploy a cloud solution, creating difficulties in the initial deployment of the cloud solution and in migrating the cloud solution to a new cloud service provider. As used herein, “cloud migration” refers to the process of moving data, applications, or workloads from one cloud environment to another or from on-premises systems to the cloud. Cloud migration can be complex, time consuming, and costly, especially when there are incompatibility issues between different cloud platforms or architectures. Cloud migration can also cause downtime, performance degradation, and/or data loss if not planned and executed properly. The disclosed technology relates to a system for implementing a cloud solution on the cloud infrastructure of a cloud service provider.

Receiving the specification for the cloud solution allows the system to determine the cloud infrastructure requirements for the cloud solution. For example, the system can receive the specification over a 5G network or any other wireless network. The system can, using a large language model (LLM), determine a list of cloud service providers with cloud infrastructure capable of hosting the cloud system and an ability to satisfy the requirements of the cloud solution. The system can rank the cloud service providers based on the capability of the cloud service provider to host the cloud solution and the ability of the cloud service provider to satisfy the requirements of the cloud system. The system can select a cloud service provider based on the ranking. The system can determine an implementation procedure. The implementation procedure is a process of deploying the cloud solution on the cloud infrastructure. The system can deploy the cloud solution using the implementation procedure.

In another embodiment, the implementation procedure causes the system to generate a common cloud source code for the cloud system. The system can use the LLM or a different LLM to generate the common cloud source code. The common cloud source code is a series of instructions that define the cloud solution. The common cloud source code is a generic programming syntax that can be converted to different programming languages or syntaxes used by the cloud service providers. Implementing a cloud solution onto the cloud infrastructure entails using a unique programming language and syntax chosen by the cloud service provider. The system can convert, using the LLM, the common cloud source code to the programming syntax of the selected cloud service provider. The system can deploy the cloud solution on the cloud infrastructure using the converted programming syntax.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

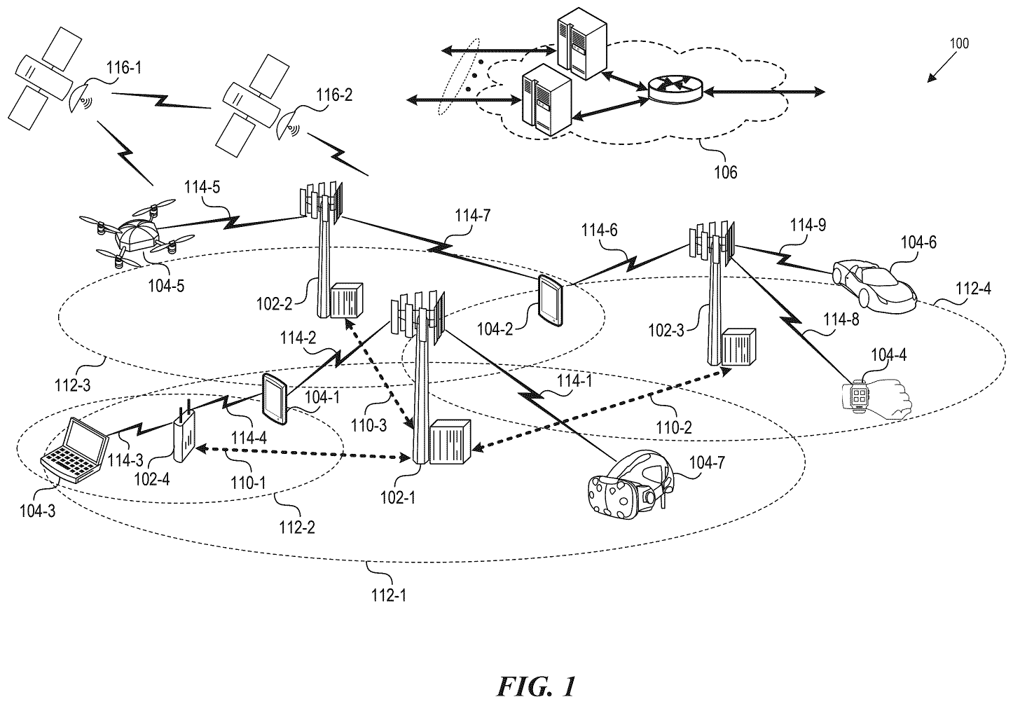

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

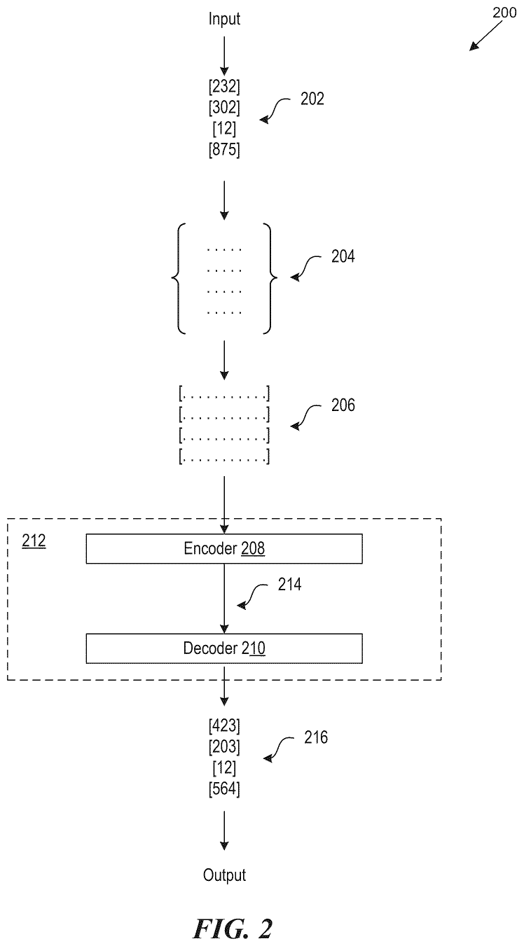

FIG. 2 is a block diagram of an example transformer 212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 212 includes an encoder 208 (which can comprise one or more encoder layers/blocks connected in series) and a decoder 210 (which can comprise one or more decoder layers/blocks connected in series). Generally, the encoder 208 and the decoder 210 each include a plurality of neural network layers, at least one of which can be a self-attention layer. The parameters of the neural network layers can be referred to as the parameters of the language model.

The transformer 212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer 212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for simplicity. In general, the token sequence that is inputted to the transformer 212 can be of any length up to a maximum length defined based on the dimensions of the transformer 212. Each token 202 in the token sequence is converted into an embedding vector 206 (also referred to simply as an embedding 206). An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some examples, the numerical value of the token 202 can be used to look up the corresponding embedding in an embedding matrix 204 (which can be learned during training of the transformer 212).

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as the latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 is able to generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some examples, the input provided to the transformer 212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Cloud Solution Deployment System

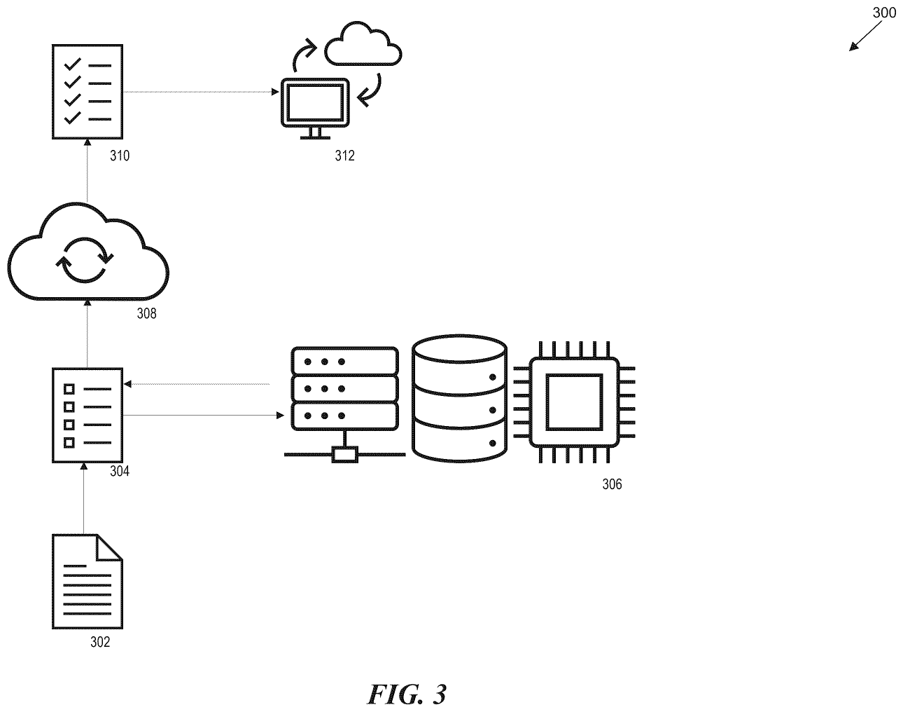

FIG. 3 illustrates an embodiment of the system 300 for selecting and implementing a new cloud solution. Data 302 can include a specification for a cloud solution including a type of cloud solution, at least one requirement of the cloud solution, and/or executable code used to execute the cloud solution. For example, the type of cloud solution can include infrastructure-as-a-service, platform-as-a-service, software-as-a-service, or function-as-a-service. The at least one requirement is a condition such as a cost, cybersecurity features, minimum processing power of the hardware running the cloud solution, etc. that a user and/or the system 300 can define for the cloud solution. The executable code can be the source code that is executed to run the cloud solution. The executable code can initially be in human-readable form and can be in any programming language, such as Python, JavaScript, Java, C++, Go, and/or Structure Query Language (SQL).

The system 300 can determine a list of cloud service providers 304 using an LLM. The list of cloud service providers can include the cloud infrastructure 306 that the cloud service provider can use to host the cloud solution. In one embodiment, the system 300 can prioritize high-efficiency cloud infrastructure. For example, high-efficiency cloud infrastructure can include high-efficiency components. High-efficiency components can generate the same processing power while simultaneously consuming less energy. Therefore, the amount of greenhouse gases generated by the system can be reduced because of the high-efficiency components that use less energy.

The system 300 can analyze the list of cloud service providers 304 and other requirements for the cloud service contained in the data 302 and input the analysis into a cloud ranking system 308. The cloud ranking system 308 can use the LLM to rank the cloud service providers based on an ability to host the cloud solution and meet any other given requirements for the cloud solution. A cloud service provider ranking list 310 can be generated by the cloud ranking system 308. For example, the cloud service providers can be ranked based on a series of criteria such as cost to host the cloud solution, security features offered by the cloud service provider, cloud infrastructure 306 components, an ability of the cloud infrastructure 306 to support a threshold user traffic volume or user traffic type, the provisioning speed of the cloud infrastructure 306, reliability of the cloud infrastructure 306, or scalability of the cloud solution on the cloud infrastructure 306.

Security features offered by the cloud service provider can include access controls to limit which employees of the cloud service provider can access the data of the cloud solution, data encryption, cyber security threat detection, compliance measures, and/or the cybersecurity protocols and training followed by the employees of the cloud service provider. Cyber security protocols can refer the policies in an employee handbook that employees must follow, this can encompass following industry standards in relation to phishing attack prevention, two-factor authentication when logging in and/or accessing cloud solution information, strong passwords, use of a virtual private network, no client information on personal devices, and/or keeping software up to date.

A threshold user traffic volume can refer to a maximum number of concurrent users accessing the cloud solution. For example, when the cloud solution is a public accessible service, the cloud criteria can be for the cloud infrastructure to be capable of hosting thousands or tens of thousands of users that are each accessing the service simultaneously. User traffic type can refer to how users interact with the cloud solution, for example, viewing content, posting content, storing data, etc. The provisioning speed of the cloud infrastructure refers to speed (e.g., amount of time) it takes for the cloud infrastructure and cloud solution to deploy, initiate, and release resources. Therefore, the provisioning speed determines how fast a user can access the cloud solution. The criteria can be a minimum threshold provisioning speed. The reliability of the cloud infrastructure can refer to a likelihood the cloud solution will be inaccessible due to an issue with the cloud service provider. The scalability of the cloud solution on the cloud infrastructure 306 refers to the cost and ease to increase and/or decrease the cloud solutions capacity on the cloud infrastructure. For example, the criteria can be for the cloud service provider to offer an automatic or minimal input to increase and/decrease the storage amount or CPU/GPU capacity.

In one example, calculating a metric score can determine the cloud service provider ranking list 310. The metric score can be calculated by assigning a weighted value to each criterion and averaging the values. In another example, the cloud service provider ranking list 310 can be determined by assigning a weighted value to a selected criterion and ranking the cloud service providers with the selected criterion. The cloud service provider with the highest value for the selected criterion can be ranked the highest.

A cloud service provider can be selected from the cloud service provider ranking list 310. For example, a cloud service provider with a high ranking can be selected. In another example, a cloud service provider can be selected based on specific criteria such as cost, a specific cloud infrastructure 306 component, or an ability to meet a given requirement specified in the cloud solution specification. When a cloud service provider is selected, an implementation procedure can be generated based on the specification of the cloud service provider's Application Programming Interface (API) contained in the data 302. The implementation procedure can be generated using the LLM. The implementation procedure can include the recommended cloud service provider, the steps for deploying the cloud solution, the cost to host and deploy the cloud solution, and/or if the cloud solution is already deployed whether or not to redeploy the cloud solution. An LLM can be used to deploy the cloud solution on the cloud infrastructure 306 of the selected cloud service provider. The LLM used to deploy the cloud solution can be the same or a different LLM as the one used to generate the implementation procedure and/or determine the cloud service provider. When the cloud solution has been deployed, a user computer 312 can access the cloud solution over a network such as a 5G or Wi-Fi network.

In some embodiments, the system simultaneously deploys multiple cloud solutions. When the system deploys multiple cloud solutions, the system can perform a combined cost analysis and metric score calculation. In some instances, cloud service providers may offer tiered pricing where the price of each cloud infrastructure component decreases as more of each individual component is used, meaning that the cost per performance index is less for a larger cloud solution or when multiple cloud solutions are hosted by the same cloud service provider. Therefore, the system can reduce the costs of hosting each cloud solution individually by hosting each cloud solution with the same cloud service provider. Additionally, the system can factor in and balance the different criteria for each cloud solution to generate, using the LLM, a cloud service provider and cloud infrastructure recommendation that meets the needs of each cloud solution while reducing costs. In some embodiments, once the multiple cloud solutions have been deployed, the system can routinely (e.g., every day, week, month) perform a determination as to whether or not to redeploy the cloud solution on the same or different cloud infrastructure. The system is able to perform both a combined and individual analysis to determine whether or not it is advantageous to keep the multiple cloud solutions deployed together or separately. The process of deploying or redeploying the multiple cloud solutions together can be the same process as deploying or redeploying a singular cloud solution.

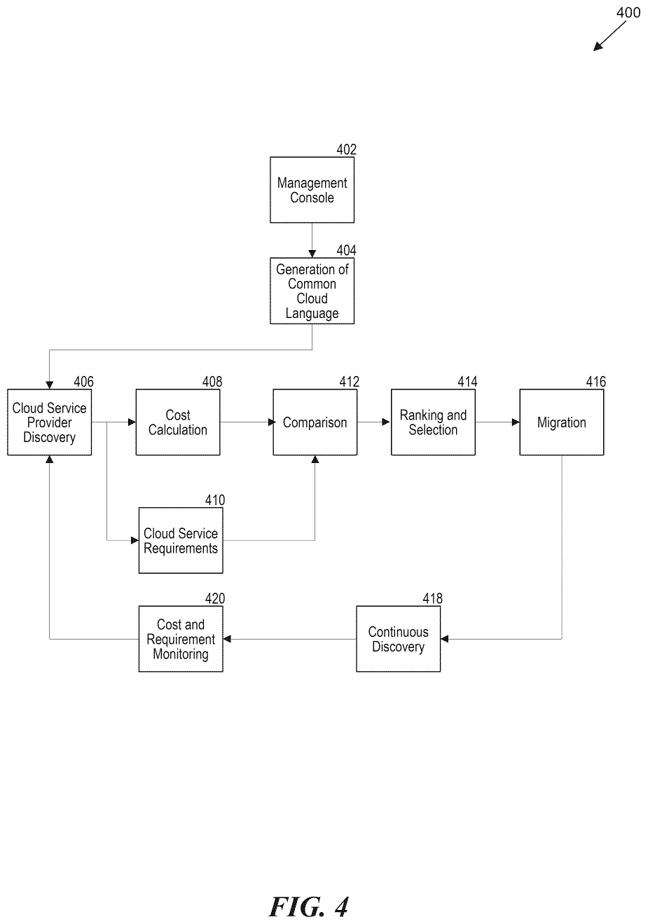

FIG. 4 illustrates a flow diagram 400 for selecting a new cloud provider for an existing cloud solution. At 402, the management console allows a user to manage the existing cloud solution. For example, the user can select an appropriate cloud workload or the number of instances needed to manage the expected transactions of the cloud solution effectively. At 404, a common cloud language can be generated based on the user's selections and the specification for the cloud solution.

In one example, the specification includes the executable code for the cloud solution, which can be written in Java. Because each programming language has a different syntax (e.g., programming vernacular and programming form), the executable code must be completely rewritten in the programming language required by the cloud service provider otherwise the cloud solution cannot be executed and run on the cloud infrastructure and software of the cloud service provider. For example, the cloud service provider can require that the cloud solution be written in Python. When the system receives the executable code, the system uses the LLM to convert the executable code into the common cloud language or generic programming code. The common cloud language can be a generic programming language that can be easily converted to different programming languages. The common cloud language reduces processing by the system and training of the LLM because the LLM does not need to be trained on how to convert every programming language to every other programming language, but only on how to convert between the common cloud language. When a cloud service provider is chosen, the system converts the common cloud language to the programming language and syntax used by the selected cloud service provider.

Generating the cloud solution in a common cloud language enables the cloud solution to be more easily deployed on new cloud infrastructure while preventing a multitude of common challenges associated with cloud technology. For example, the common cloud language can prevent vendor lock-in, which is a phenomenon where a cloud solution customer does not migrate the cloud solution to a different cloud service provider due to the perceived complexity and cost of the migration, by reducing the cost and complexity of the migration. A user can migrate the cloud solution when cost savings opportunities arise. The common cloud language can help prevent cost optimization shortcomings by providing updated pricing information for different cloud service providers while allowing the cloud solution to be easily migrated to a lower-cost cloud service provider. The common cloud language can also decrease the occurrence of coding errors or bugs, that prevent the cloud solution from being executable.

At 406, the cloud service provider discovery process can occur. The discovery process can include searching for cloud service providers that meet the requirements of the cloud solution. At 408, a cost calculation for each discovered cloud service provider can occur. For example, the cost calculation can include the cost to host and maintain the cloud solution on the cloud service provider's cloud infrastructure. The cost calculation can be a monthly cost or a yearly cost. In another example, the cost calculation can be normalized based on the cloud service provider's cloud infrastructure. Normalizing the cost calculation allows for a more accurate comparison between the different service providers when the cloud service providers do not have identical cloud infrastructure. The normalized cost calculation gives a single comparable number that represents a uniform price per performance value.

At 410, the requirements of the cloud service provider to deploy the cloud solution can be determined for each cloud service provider. At 412, the cloud service providers can be compared. The cloud service providers can be compared based on multiple factors such as cost, historical costs, historical price increases, security features offered by the cloud service provider, cloud infrastructure components, the ability of the cloud infrastructure to support a threshold user traffic volume or user traffic type, the provisioning speed of the cloud infrastructure, reliability of the cloud infrastructure, or scalability of the cloud solution on the cloud infrastructure. Additionally, the cloud service providers can be compared based on the requirements each cloud service provider has to implement a cloud solution on their cloud infrastructure.

At 414, the cloud service providers can be ranked based on the comparison. For example, the cloud service provider with the highest overall ranking for each factor used in the comparison can be ranked the highest. In another example, the highest-ranking cloud service provider can be the cloud service provider with the highest ranking for one factor, such as cost or security features. A cloud service provider can be selected based on the ranking where, for example, the highest-ranking or a high-ranking cloud service provider is selected. At 416, the cloud solution can be migrated from a current cloud service provider to the selected cloud service provider.

At 418, a continuous discovery process is performed. For example, the continuous discovery process can include determining updates to the cloud service provider's pricing structure or cloud infrastructure. The system can store historical hosting costs of the cloud solution to calculate a trend in the hosting costs. The system can analyze the trend data to determine when to recommend a redeployment, whether any price increases are standard across the market or cloud provider specific, and/or determine when to start the continuous discovery process 418.

At 420, the cost of the cloud solution and the requirement of the cloud solution can be monitored. For example, the cloud solution can be monitored for an increase in the price to host the cloud solution of the current cloud service provider. The cloud service provider's ability to meet a given requirement of the cloud solution can also be monitored. When a current cloud service provider fails to meet a given requirement or when a price increase beyond a certain threshold occurs, the process can begin again at 406.

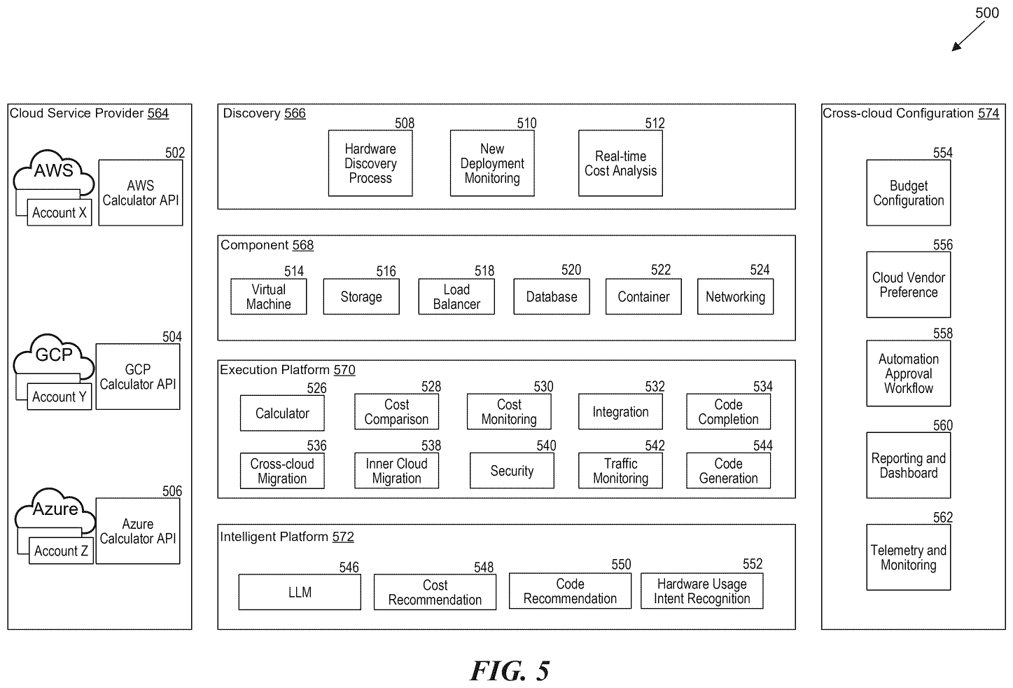

FIG. 5 illustrates a block diagram 500 of the various features of an embodiment of the system. The cloud service provider box 564 can contain the various cloud service providers hosting the different cloud solutions controlled by a user. For example, Amazon Web Services (AWS) can host account X. The system can use an AWS calculator API 502 to determine AWS's unique programming syntax used to deploy and maintain the cloud solution for account X. Google Cloud Platform (GCP) can host account Y. The system can use a GCP calculator API 504 to determine GCP's unique programming syntax used to deploy and maintain the cloud solution for account Y. Azure can host account Z. The system can use an Azure calculator API 506 to determine Azure's unique programming syntax used to deploy and maintain the cloud solution for account Z.

The discovery box 566 can be the processes and interactions for the user to implement or redeploy a cloud solution. The user can leverage a console to articulate their requirements, such as a cloud service provider preference, a new workload to be deployed, or a cost requirement. The user can use the hardware discovery process 508 to determine the hardware requirements of the cloud solution and/or to determine the hardware components offered in the cloud infrastructure of a cloud service provider. The hardware discovery process 508 can use an LLM to determine which hardware components are needed to support the cloud solution. The LLM can analyze the cloud solution to determine a required amount of processing power (e.g., CPU performance), random access memory (RAM) amount, RAM speed (e.g., transfer speed), storage space (e.g., hard drive capacity), storage speed (e.g., hard drive read/write speed), storage type (e.g., hard drive disk vs solid state hard drive), graphical processing power (e.g., GPU performance), and/or network bandwidth (e.g., upload and download speeds). For example, the LLM can determine, based on the type of cloud solution and/or an expected number of concurrent users, that the cloud solution requires 8 multicore CPUs with a CPU clock speed of at least 3.5 GHZ, 256 gigabytes of 6000 MT/s DDR5 RAM, a 3 terabytes of solid state hard drive with 7,450/6,900 MBps of sequential read/write throughput and 1.2/1.55 million read/write input/output operations per second (IOPS), 6 GPUs with at least 32 GB of memory and 1600 GM/sec memory bandwidth, and a minimum of 1 GB/s network download speed and 200 MB/s network upload speed. In some embodiments, the LLM can be a general off the shelf LLM with no specific training. In some other embodiments, the LLM is specifically trained to determine the hardware requirements for the cloud solution. For example, the LLM can be trained using a specifically generated dataset that includes different cloud solutions and the minimum hardware requirements for the cloud solutions. The LLM can also be trained using current and past cloud solutions including the type cloud solution and the hardware that successfully hosted the cloud solution.

When the cloud solution is currently deployed at a cloud service provider, the LLM can analyze the current usage of the cloud infrastructure. For example, based on the specific training of the LLM, the LLM can determine what percentage of full capacity the cloud infrastructure is at. When the cloud infrastructure is passed a threshold capacity (e.g., 80-90 percent), the LLM can initiate the process of increasing the capacity or redeploying the cloud solution. When the cloud solution is below a threshold capacity (e.g., 50 percent), the LLM can initiate the process of decreasing capacity or redeploying the cloud solution to different cloud infrastructure to lower costs.

The new deployment monitoring 510 can monitor the cloud service providers to determine requirements for deployment or migration of the cloud solution. The real-time cost analysis 512 can monitor the cloud service providers to determine the deployment or migration cost of the cloud solution and/or the hosting cost of the cloud solution. This can allow a user to know the process and cost of deploying the cloud solution or the cost of hosting the cloud solution for multiple cloud service providers. Additionally, this aids in sizing the cloud infrastructure, workloads, and pricing to align with the user's needs or requirements.

The component box 568 can be the cloud infrastructure components used to host and execute the cloud solution. For example, a cloud service provider's cloud infrastructure components can include a virtual machine 514, storage 516, a load balancer 518, a database 520, a container 522, and networking components 524. The cloud infrastructure components can be unique to each cloud service provider. For example, AWS can have different cloud infrastructure components than GCP or Azure. Additionally, the different cloud service providers can use a unique naming nomenclature or terminology for the different cloud infrastructure components, causing the same cloud infrastructure components to have different names for the each cloud service provider. Additionally, the different cloud infrastructure components can be supported by different APIs. However, the system can control for the differences in terminology used by the cloud service providers by converting the terminology to a unified component terminology that allows a user to use consistent terminology when interacting with the different cloud service providers.

The execution platform box 570 can contain and control the core operations and tools of the system. For example, the execution platform box 570 can contain the calculator 526. The calculator 526 can integrate with cost calculation APIs from multiple cloud service providers to enable precise cost assessments for various configurations and workloads implemented on different cloud infrastructure. For example, calculator 526 can calculate the cost of hosting a cloud solution with a virtual machine (VM) with a specific configuration, such as 2 CPUs and 4 gigabytes of memory, for a day or week on the cloud service provider's cloud infrastructure. Multiplying the cost per VM by the total number of VMs can show the cloud solution's daily, weekly, monthly, or yearly operational costs.

The cost comparison tool 528 can compare the hosting cost of the cloud solution for the different cloud service providers. For example, the cost comparison tool 528 can account for differences in the cloud infrastructure components when comparing costs. The cost monitoring tool 530 can monitor the costs of different cloud service providers to determine if migrating the cloud solution to a different cloud service provider would generate a cost savings for the user. The integration tool 532 can determine the processes and requirements to integrate the cloud solution on the cloud infrastructure of a cloud service provider. The code completion tool 534 can determine the code required to deploy the cloud solution. Additionally, the code completion tool 534 can monitor the code generated by the code generation tool 544 to determine whether the code complies with the required criteria of the cloud service provider. The code completion tool 534 can use an LLM to determine the different code and/or API requirements of each cloud service provider. The LLM can determine the different requirements by analyzing the cloud service provider's website, the cloud service providers training manuals, a specifically generated requirements manual, and/or by retrieving the requirements from a database of cloud service provider requirements. In some embodiments, the LLM stores the requirements for each cloud service provider and performs a verification to determine if there has been an update to the requirements. When there has been an update, the LLM updates the stored requirements. The code generation tool 544 can generate the code required to deploy the cloud solution. In one example, code completion tool 534 and the code generation tool 544 can use an LLM to generate the required code. The LLM is therefore able to generate code that follows every protocol required by the cloud service provider to ensure there is a seamless deployment of the cloud solution on the cloud infrastructure. In some embodiments, the LLM first converts the executable code of the cloud solution to a generic programming code/common cloud source code and then saves the generic programming code to an accessible database. When a cloud service provider is chosen, the LLM converts the generic programming code to the programming language required by the cloud service provider (e.g., Python, JavaScript, Java, C++, Go, and/or SQL). Converting the generic programming code involves generating or writing the code in the form required by the required programming syntax. Additionally, because difference cloud service providers can require the use of certain terms or have unique names for certain terms, converting the executable code to a generic code ensures that each term or unique name required by the cloud service provider is appropriately used.

The cross-cloud migration tool 536 can monitor and control the migration of the cloud solution from one cloud service provider to a different cloud service provider. The inner cloud migration tool 538 can monitor and control the migration of the cloud solution to different cloud infrastructure of the same cloud service provider currently hosting the cloud solution. The security tool 540 can determine the security protocols and features offered by the different cloud service providers. The security tool 540 can monitor the cloud solution for security risks and vulnerabilities and can notify the user if a cyberattack or security threat or anomaly is detected. The traffic monitoring tool 542 can monitor the amount of user traffic volume, user traffic type, and/or how each user is interacting with the cloud solution. Using the security tool 540 and the traffic monitoring tool 542 the system can analyze the deployed cloud solution to determine and detect suspicious activity related to the cloud solution. For example, the security tool 540 can analyze data generated by the traffic monitoring tool 542 to determine that one or more users are performing suspicious actions such as unexpected password resets, logins from unexpected locations, unusual network traffic, unauthorized access attempts, unexpected behavior of the cloud solution such as crashing, changes to system setting, files becoming inaccessible, a sudden increase in phishing attempts, and/or detected activity by the firewall. When the system determines the existence of one of these factors beyond a threshold amount determined by the type of suspicious activity, the system generates the notification to the user. In some embodiments, the security tool 540 includes an LLM to analyze the data, the LLM can be the same LLM as LLM 546 or a different LLM. The LLM can be specifically trained to detect the suspicious activity using past data that includes both normal and suspicious data and/or a specifically made training dataset. In some other embodiments, the LLM is a generic LLM that is not specifically trained. The generic LLM can have access to a standard set of baseline data with no suspicious activity, the generic LLM can then be caused to compare all incoming data against the baseline data. When the generic LLM detects a difference between the baseline data and the new data, the user is notified.

Combining the data generated from the different tools, such as user traffic volume and type, with user-defined configurations assists the system in recommending the most suitable cloud infrastructure and migration strategies.

The intelligent platform box 572 can provide plain-language recommendations to the user based on the data and recommendations received from the execution platform. The intelligent platform box 572 can use an LLM 546 to generate recommendations. The cost recommendation tool 548 can use the LLM 546 to generate a recommended cost to host the cloud solution. For example, the cost recommendation tool 548 can display to the user the expected cost to host the cloud solution for a given time period or the average cost to host the cloud solution. For example, the average cost to host the cloud solution can be calculated by averaging the cost calculation of each cloud service provider.

The code recommendation tool 550 can display to the user the recommended code used to deploy the cloud solution on the cloud service provider's cloud infrastructure. The hardware usage intent recognition tool 552 can recommend the different cloud infrastructure components to a user based on the stated intent of the user and the execution platform tools.

The cross-cloud configuration box 574 can act as the central portal for users to input the requirements for the cloud solution using the unified component terminology. The budget configuration tool 554 can allow a user to input a given budget. For example, a user can specify a minimum or maximum budget for the cloud solution. The cloud vendor preference tool 556 allows a user to specify a preferred cloud vendor. For example, a user may prefer to use either AWS or GCP and not Azure, and the cloud vendor preference tool 556 allows the user to input this preference. The automation approval workflow tool 558 can allow the user to approve the actions taken by the system. Approving the system's actions can allow the user to supervise the system's actions and prevent any unwanted actions. The reporting and dashboard 560 can display information relating to the cloud solution, such as the selected cloud service provider, cloud infrastructure components, or cost. The telemetry and monitoring tool 562 can display the status of the cloud solution. For example, the telemetry and monitoring tool 562 can indicate that the cloud solution is functioning correctly or that an error must be addressed. The cross-cloud configuration can allow for the management of multiple cloud solutions and allows the user to make real-time data-driven decisions about the cloud solution.

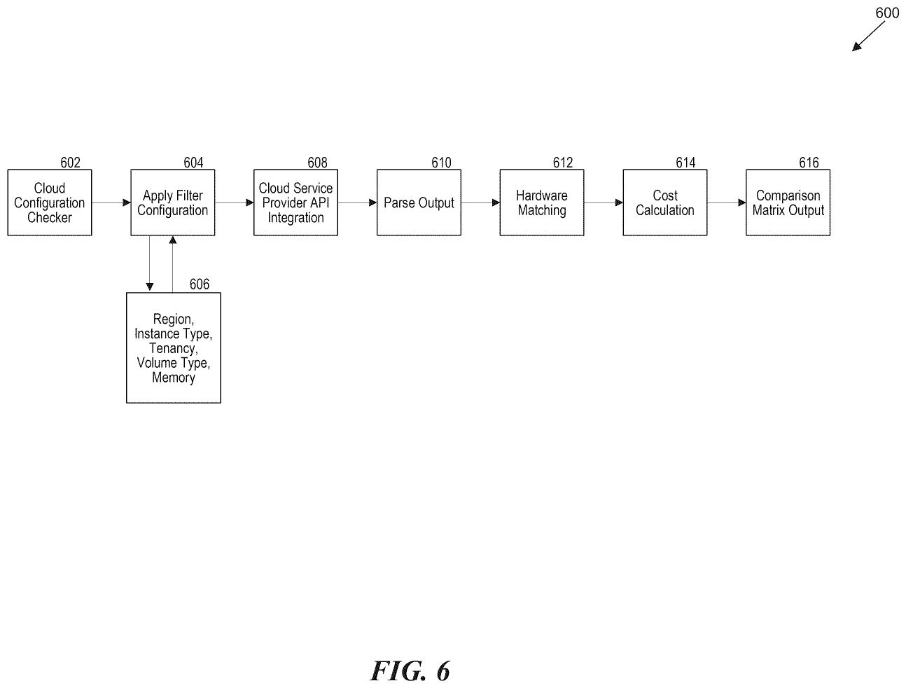

FIG. 6 illustrates a flow diagram of an embodiment of a calculator tool 600 for the system. The calculator tool 600 can conduct cost calculations for the different cloud infrastructure offered by different cloud service providers. At 602, the cloud configuration checker can receive the determined or specified cloud configuration needed to run and host the cloud solution. For example, the cloud configuration checker can receive an indication of the chosen or needed cloud infrastructure components. At 604, a filter configuration can be applied. For example, at 606, the filter configuration can receive multiple filter criteria. The filter criteria can include a region, instance type, tenancy, volume type, and/or memory type or amount.

At 608, the cloud service provider API integration can occur. The cloud service provider API integration allows the API of the system to communicate and receive data and information from the API from a cloud service provider. Converting the terminology can allow the system to determine the exact cloud infrastructure components that will be used for a given cloud service provider, which can allow the system to calculate a more accurate cost calculation. At 610, the output can be parsed to convert it to a more suitable format for the calculator tool 600 to use during the cost calculation.

At 612, the hardware matching tool can match the unified terminology used to select the cloud infrastructure with the unique language used by a cloud service provider. At 614, the cost calculation can occur. The cost calculation determines the final cost for the cloud solution to be run and hosted by a cloud service provider. The cost calculation can be for the cloud solution's daily, weekly, monthly, or yearly cost. At 616, a cost comparison matrix can be outputted. The cost comparison matrix can include the cost calculation for multiple cloud service providers. In one example, the cost comparison matrix is displayed to the user.

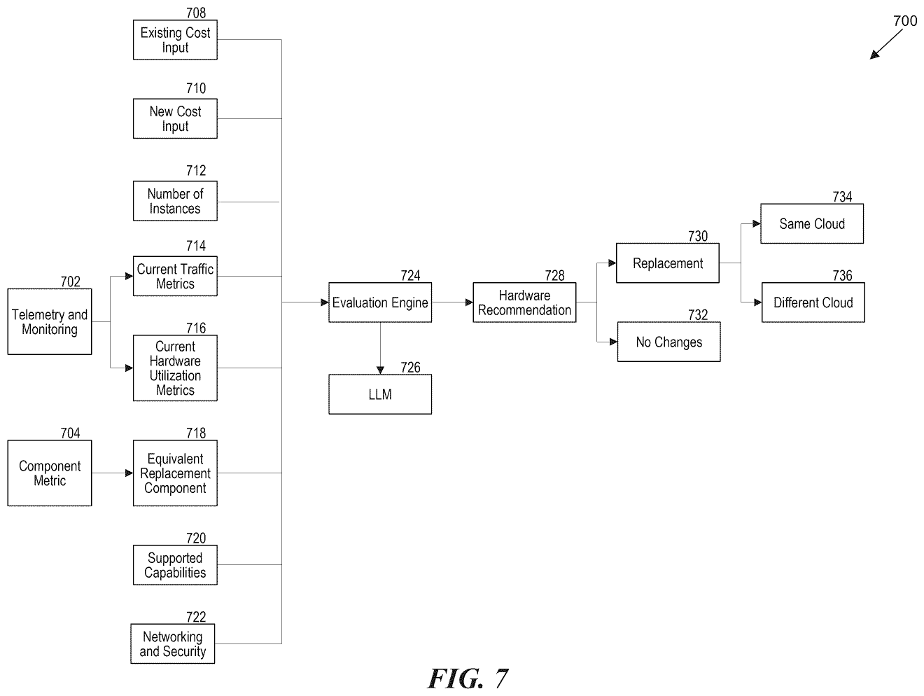

FIG. 7 illustrates a flow diagram for an embodiment of the recommendation process 700 for recommending a cloud service provider when the cloud solution is currently deployed on the cloud infrastructure of a cloud service provider. For example, the recommendation process 700 can recommend changing cloud service providers or not changing cloud service providers. The recommendation process can also recommend changing the cloud infrastructure used to host the cloud solution to improve pricing and/or efficiency. The recommendation process 700 can occur at set intervals to ensure that the cloud solution is always deployed at the lowest cost. For example, the recommendation process 700 can occur every hour, day, week, month, etc. The recommendation can be based on a variety of different types of data. For example, the recommendation process 700 can factor in existing cost input 708, new cost input 710, the number of instances 712, and/or telemetry and monitoring data 702. The telemetry and monitoring data 702 can include current traffic metrics 714 and/or current hardware utilization metrics 716. The recommendation process 700 can also factor in component metrics 704, such as equivalent replacement components 718, supported capabilities 720, and/or networking and security 722.

An evaluation engine 724 can evaluate the different types of data using an LLM 726 and can input the evaluation into the hardware recommendation 728. The LLM 726 can use algorithms to identify suitable replacement components based on the analyzed different types of data. The evaluation engine 724 can, at set intervals, identify all actively running components and accounts and determine the number of instances within each one. This enables the system to determine a current status of the cloud solution to help better achieve cost savings. The hardware recommendation 728 can recommend different cloud infrastructure components to use for the cloud solution. The hardware recommendation 728 can recommend no change 732 to the cloud infrastructure. The hardware recommendation 728 can recommend replacement 730 of the cloud infrastructure. When the hardware recommendation 728 recommends a replacement 730, the replacement can cause a recommendation for new cloud infrastructure on the same cloud 734 or new cloud infrastructure on a different cloud 736. For example, a different cloud 736 can be a cloud solution offered by a cloud service provider that is different from the cloud service provider currently hosting the cloud solution.

By performing the recommendation process 700, the user can know which cloud infrastructure components are currently active, the specifications of the components to facilitate alignment with newer and/or different alternatives, and assess how effectively the cloud infrastructure is being utilized. The recommendation process 700 can also give insights into the functionality of current components.

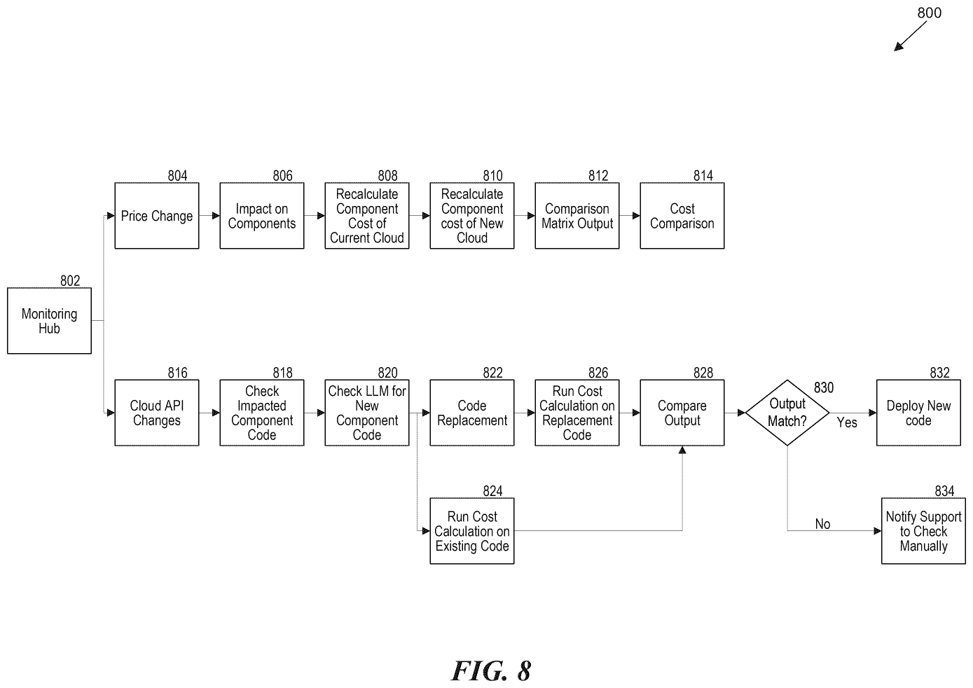

FIG. 8 illustrates a flow diagram of an embodiment 800 of the monitoring hub 802. The monitoring hub 802 can monitor price changes 804 and/or cloud API changes 816. For example, user interaction or approval can only be required when a price or API change occurs.

When a price change 804 occurs, there can be an impact on the components 806. For example, the cost to maintain the cloud solution on the components can decrease, allowing for cost savings for the user. The decrease in cost can also occur for a different cloud service provider, causing a cost impact on the components 806. At 808, a recalculation of the component cost for the current cloud can occur. At 810, the component cost for the new cloud is recalculated. At 812, the monitoring hub can generate a comparison matrix output, which can include the recalculations for the current and new cloud. At 814, the monitoring can generate a cost comparison based on the comparison matrix. A user can use the cost comparison to approve a change to the cloud solution, such as approving a change to move the cloud solution to a different cloud service provider.

When a cloud API change 816 occurs, existing code can need updating to keep the cloud solution functioning correctly. At 818, the monitoring hub 802 can check for impacted component code. At 820, the monitoring hub 802 can use the LLM to check for new component code. At 822, the monitoring hub 802 can receive replacement code that can be used for a cost calculation. At 824, the monitoring hub 802 can run a cost calculation on the existing code. At 826, the monitoring hub 802 can run a cost calculation on the replacement code. At 828, the monitoring hub 802 can output a comparison of the cost calculation on the existing code and the replacement code. At 830, the monitoring hub 802 can determine if the output matches. For example, the outputs can match when the cost comparison is the same, and the cloud solution functions similarly with the replacement code and existing code. At 832, the output matches, and the monitoring hub 802 can deploy the new replacement code. At 834, the output does not match, and the monitoring hub 802 can notify the user or a support system to check the outputs manually. Generating new code for changes in the API specification allows for continuous integration and continuous deployment processes to be followed, which can ensure the cloud solution is not affected by evolving API requirements.

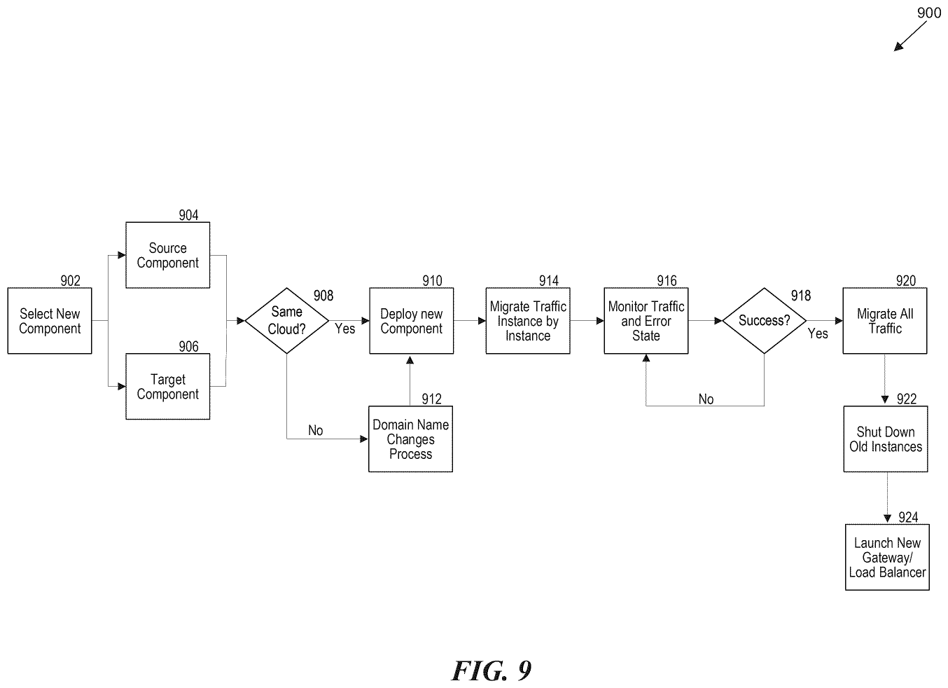

FIG. 9 illustrates a flow diagram of an embodiment 900 for replacing a cloud infrastructure component without impacting end-user traffic. At 902, a determination can be made to select a new component. Depending on the type of component selected, a different step can occur. For example, step 904 can occur when a source component is selected, and step 906 can occur when a target component is selected. At 908, a determination can be made as to whether the selected new component will be implemented on the same cloud. When the implementation does not occur on the same cloud, step 912 can occur. At 912, the domain name changes process can occur. When the domain name changes process has occurred, step 910 can occur. Additionally, step 910 can occur when the selected new component is determined to be implemented on the same cloud. At 910, the new component is deployed.

At 914, the traffic can be migrated instance by instance onto the newly deployed component. For example, migrating the traffic instance by instance can help prevent large-scale issues by only allowing minimal traffic on the new component to determine if it was correctly deployed with no errors. Migrating traffic this way becomes more important when the new component is deployed on a new cloud as more components need to be migrated and errors can be more frequent. At 916, the traffic can be monitored along with the error state. At 918, the system can determine if the deployment of the new component was a success. When an error occurs, the system stays at 916 and continues monitoring the new component's traffic and error state. When a success occurs, step 920 occurs. At 920, all traffic is migrated to the new component. At 922, a shutdown of old instances on the old component can occur. At 924, a new gateway and load balancer can be launched.

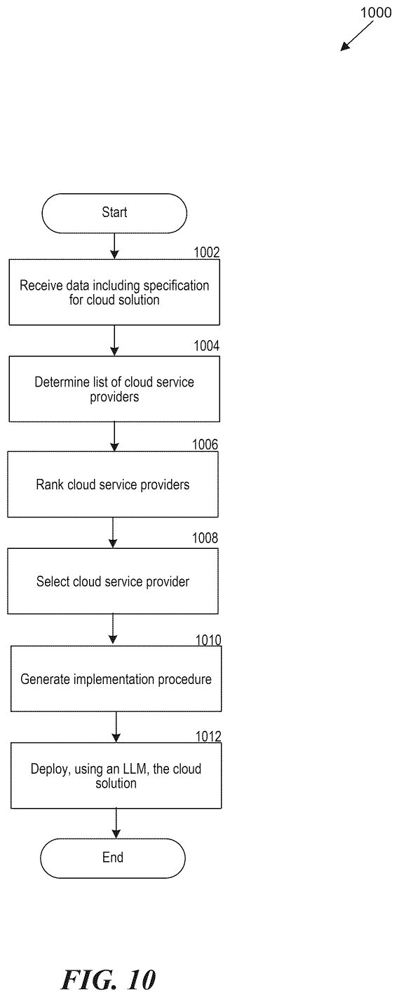

FIG. 10 is a flow diagram illustrating an embodiment of a cloud migration process. In one example, the tool can be embodied in a computer system, the system including at least one hardware processor and at least one non-transitory memory storing instructions, which, when executed by the at least one hardware processor, cause the system to perform the process 1000.

At 1002, the system can receive data, including a specification for a cloud solution. The cloud solution includes a computing service implemented on the cloud infrastructure of a cloud service provider. The specification for the cloud solution indicates a type of cloud solution and at least one requirement of the cloud solution. The type of cloud solution includes infrastructure-as-a-service, platform-as-a-service, software-as-a-service, or function-as-a-service. In one example, the at least one requirement includes an ability of the cloud infrastructure to support a threshold user traffic volume or a user traffic type, provisioning speed of the cloud infrastructure, reliability of the cloud infrastructure, security protocols, technology, or controls enacted by the cloud service provider, scalability of the cloud solution on the cloud infrastructure where scalability of the cloud solution is the ability to increase the amount of computing power, storage, or bandwidth provided to the cloud solution, or cost to host the cloud service on the cloud infrastructure of the cloud service provider.

At 1004, the system can determine a list of cloud service providers having a cloud infrastructure that is capable of hosting the cloud solution and an ability to satisfy the at least one requirement of the cloud solution. The cloud infrastructure includes hardware components and software that the cloud solution is hosted on. In one example, the system lowers an amount of greenhouse gas emissions by prioritizing the deployment of the cloud solution on high-efficiency hardware components of the cloud infrastructure, which reduces an amount of energy consumed to host the cloud solution on the cloud infrastructure.

At 1006, the system can rank the cloud service providers based on the capability to host the cloud solution and the ability to satisfy the at least one requirement of the cloud solution. In one example, the system includes a user interface. The system can calculate a metric score for each cloud service provider on the list of cloud service providers. The metric score is a calculation that converts the at least one requirement to a single number. The system can retrieve the metric score from a database and cause display of the metric score and can cause display of the ranking of cloud service providers.

At 1008, the system can select the cloud service provider based on the ranking of cloud service providers, where the cloud service provider selected is ranked above a threshold ranking.

At 1010, the system can generate an implementation procedure based on an Application Programming Interface (API) specification of the cloud service provider, where the implementation procedure includes a process of deploying the cloud solution on the cloud infrastructure of the cloud service provider. The API specification determines a requirement for the cloud solution to be deployed on the cloud infrastructure. In one example, the implementation procedure can cause the system to generate, using the LLM, a common cloud source code, where the common cloud source code is a generic programing code or syntax that is a series of instructions defining the cloud solution. The system can convert, using the LLM, the common cloud source code to the programming syntax required for the API of the cloud service provider. Each cloud service provider uses a unique programming syntax, and converting the common cloud source code to the programming syntax of the cloud service provider allows the cloud solution to be deployed on the cloud infrastructure of the cloud service provider. The system can deploy, using the programming syntax of the cloud service provider, the cloud solution on the cloud infrastructure of the cloud service provider.

At 1012, the system can deploy, using a large language model (LLM), the cloud solution on the cloud infrastructure of the cloud service provider in accordance with the implementation procedure where the LLM generates a programming syntax required for the API. Deploying the cloud solution can include transmitting the converted code over a W-Fi or 5G network to the cloud service provider and/or by uploading the converted code to an online platform. Additionally, the process to deploy the cloud solution can be identical as the process of redeploying the cloud solution and vice versa.

In one example, where the cloud solution is migrated from a current cloud service provider to a new cloud service provider, the system can search for the new cloud service provider. The system can rank the new cloud service provider against the current cloud service provider, where the new cloud service provider ranks above the current cloud service provider. The system can deploy the cloud solution on the cloud infrastructure of the new cloud service provider. Deploying the cloud solution includes removing the cloud solution from the cloud infrastructure of the current cloud service provider and where no disruption to the cloud solution occurs during the deployment of the cloud solution on the cloud infrastructure of the new cloud service provider.

In one example, where the cloud solution is deployed on the cloud infrastructure of a current cloud service provider, the system can determine an updated list of cloud service providers. The system can rank the updated list of cloud service providers against the current cloud service provider. The current cloud service provider ranks above the updated list of cloud service providers. The system can evaluate the cloud service provider based on the at least one requirement. The evaluation determines that redeploying the cloud solution increases the ability of the cloud infrastructure of the cloud service provider to satisfy the at least one requirement. The system can determine an updated implementation procedure, where the updated implementation procedure is a process of redeploying the cloud solution on the cloud infrastructure of the cloud service provider. The system can redeploy the cloud solution on the cloud infrastructure of the cloud service provider based on the updated implementation procedure.

### Computer System

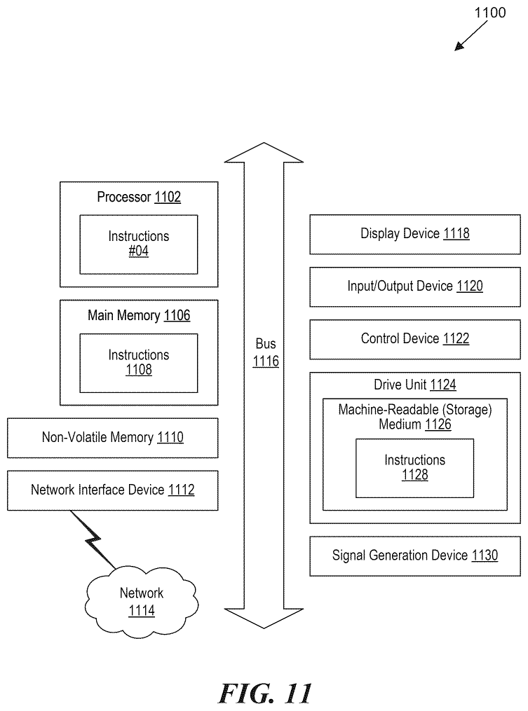

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a video display device 1118, an input/output device 1120, a control device 1122 (e.g., keyboard and pointing device), a drive unit 1124 that includes a machine-readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computing system 1100 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1100. In some implementations, the computer system 1100 can be an embedded computer system, a system-on-chip (SOC), a single-board computer system (SBC), or a distributed system such as a mesh of computer systems, or it can include one or more cloud components in one or more networks. Where appropriate, one or more computer systems 1100 can perform operations in real time, in near real time, or in batch mode.

The network interface device 1112 enables the computing system 1100 to mediate data in a network 1114 with an entity that is external to the computing system 1100 through any communication protocol supported by the computing system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computing system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computing system 1100 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system comprising:
at least one hardware processor; and
at least one non-transitory memory storing instructions, which, when executed by the at least one hardware processor, cause the system to:
receive data including a specification for a cloud solution,
wherein the cloud solution includes a computing service implemented on a cloud infrastructure of a cloud service provider,
wherein the specification for the cloud solution indicates a type of cloud solution, at least one requirement of the cloud solution, and executable code used to execute the cloud solution, and
wherein the type of cloud solution includes infrastructure-as-a-service, platform-as-a-service, software-as-a-service, or function-as-a-service;
determine, using a large language model (LLM), a list of the cloud infrastructure required to satisfy at least one requirement,
wherein the cloud infrastructure includes hardware components and software that the cloud solution is hosted on;
determine, using the LLM, a list of cloud service providers having cloud infrastructure capable of hosting the cloud solution and an ability to satisfy the at least one requirement of the cloud solution,
calculate a metric score for each of the cloud service providers based on a weighted value for each requirement of the at least one requirement of the cloud solution,
wherein the metric score indicates a capability to satisfy the at least one requirement of the cloud solution;
rank the cloud service providers based on the capability to host the cloud solution and the ability to satisfy the at least one requirement of the cloud solution;
generate, using the LLM, an implementation procedure based on an Application Programming Interface (API) specification of the cloud service provider and the ranking of the cloud service providers,
wherein the implementation procedure includes a selected cloud service provider and at least one cloud service provider requirement for deploying the cloud solution on the cloud infrastructure of the cloud service provider, and
wherein the API specification determines how the executable code of the cloud solution is modified for deployment on the cloud infrastructure; and
deploy, using the LLM, the cloud solution on the cloud infrastructure of the cloud service provider in accordance with the implementation procedure,
wherein the LLM converts the executable code of the cloud solution to a programming syntax required by the API specification.

2. The system of claim 1, wherein the cloud solution is migrated from a current cloud service provider to a new cloud service provider, the instructions further cause the system to:
search for the new cloud service provider;
rank the new cloud service provider against the current cloud service provider,
wherein the new cloud service provider ranks above the current cloud service provider; and
deploy the cloud solution on the cloud infrastructure of the new cloud service provider,
wherein deploying the cloud solution includes removing the cloud solution from the cloud infrastructure of the current cloud service provider, and
wherein no disruption to the cloud solution occurs during the deployment of the cloud solution on the cloud infrastructure of the new cloud service provider.

3. The system of claim 1, wherein the implementation procedure further causes the system to:
convert, using the LLM, the executable code of the cloud solution to a generic programming code;
save the generic programming code to a database accessible by the LLM;
convert, using the LLM, the generic programming code to the programming syntax required for the API of the cloud service provider,
wherein each cloud service provider uses a unique programming syntax, and
wherein converting the generic programming code to the programming syntax of the cloud service provider enables the cloud solution to be deployed on the cloud infrastructure of the cloud service provider; and
deploy, using the unique programming syntax of the cloud service provider, the cloud solution on the cloud infrastructure of the cloud service provider.

4. The system of claim 1, wherein the at least one requirement includes:
an ability of the cloud infrastructure to support a threshold number of simultaneous user traffic volume or a user traffic type;
a threshold provisioning speed of the cloud infrastructure,
wherein provisioning speed is a maximum time for the cloud infrastructure to deploy, initiate, or release resources;
reliability of the cloud infrastructure;
cybersecurity protocols the cloud service provider requires employees to follow;
cybersecurity technology enacted by the cloud service provider;
scalability of the cloud solution on the cloud infrastructure,
wherein scalability of the cloud solution is the ability to increase an amount of computing power, storage, or bandwidth provided to the cloud solution; or
cost to host the cloud solution on the cloud infrastructure of the cloud service provider.

5. The system of claim 1, wherein the cloud solution is deployed on the cloud infrastructure of a current cloud service provider, the instructions further cause the system to:
determine, using the LLM, an updated list of cloud service providers;
rank the updated list of cloud service providers against the current cloud service provider,
wherein the current cloud service provider ranks above the updated list of cloud service providers;
evaluate, using the LLM, the cloud service provider based on the at least one requirement,
wherein the evaluation determines that redeploying the cloud solution increases the ability of the cloud infrastructure of the cloud service provider to satisfy the at least one requirement;
determine, using the LLM, an updated implementation procedure,
wherein the updated implementation procedure is a process of redeploying the cloud solution on the cloud infrastructure of the cloud service provider; and
redeploy, using the LLM, the cloud solution on the cloud infrastructure of the cloud service provider based on the updated implementation procedure.

6. The system of claim 1, wherein the system includes a user interface, the system being further caused to:
retrieve the metric score for each cloud service provider on the list of cloud service providers,
wherein the metric score is a calculation that converts the at least one requirement to a single number;
cause display of the metric score and a cost to host the cloud solution; and
cause display of the ranking of cloud service providers.

7. The system of claim 1, further cased to:
monitor, using the LLM, the deployed cloud solution for a cybersecurity threat;
detect, based on an anomaly in data generated by the cloud solution, the cybersecurity threat,
wherein the anomaly is caused by at least one of the following: unexpected password resets, user logins from unexpected locations, an increase in unauthorized access attempts beyond a threshold number, or unauthorized changes to a cloud solution system setting;
generate a notification indicating the detection of the cybersecurity threat.

8. A non-transitory, computer-readable storage medium comprising instructions recorded thereon, wherein the instructions, when executed by at least one data processor of a system, cause the system to:
receive data including a specification for a cloud solution,
wherein the cloud solution includes a computing service implemented on a cloud infrastructure of a cloud service provider,
wherein the specification for the cloud solution indicates a type of cloud solution, at least one requirement of the cloud solution, and executable code used to execute the cloud solution, and
determine, using a large language model (LLM), a list of the cloud infrastructure required to satisfy at least one requirement,
determine, using the LLM, a list of cloud service providers having cloud infrastructure capable of hosting the cloud solution and an ability to satisfy the at least one requirement of the cloud solution,
rank the cloud service providers based on the capability to host the cloud solution and the ability to satisfy the at least one requirement of the cloud solution;
generate, using the LLM, an implementation procedure based on an Application Programming Interface (API) specification of the cloud service provider and the ranking of the cloud service providers,
wherein the implementation procedure includes a selected cloud service provider and at least one cloud service provider requirement for deploying the cloud solution on the cloud infrastructure of the cloud service provider; and
deploy, using the LLM, the cloud solution on the cloud infrastructure of the cloud service provider in accordance with the implementation procedure,
wherein the LLM converts the executable code of the cloud solution to a programming syntax required by the API specification.

9. The non-transitory, computer-readable storage medium of claim 8, wherein the cloud solution is migrated from a current cloud service provider to a new cloud service provider, the instructions further cause the system to:
search for the new cloud service provider;
rank the new cloud service provider against the current cloud service provider,
wherein the new cloud service provider ranks above the current cloud service provider; and
deploy the cloud solution on the cloud infrastructure of the new cloud service provider,
wherein deploying the cloud solution includes removing the cloud solution from the cloud infrastructure of the current cloud service provider, and
wherein no disruption to the cloud solution occurs during the deployment of the cloud solution on the cloud infrastructure of the new cloud service provider.

10. The non-transitory, computer-readable storage medium of claim 8, wherein the implementation procedure further causes the system to:
convert, using the LLM, the executable code of the cloud solution to a generic programming code;
save the generic programming code to a database accessible by the LLM;
convert, using the LLM, the generic programming code to the programming syntax required for the API of the cloud service provider,
wherein each cloud service provider uses a unique programming syntax, and
wherein converting the generic programming code to the programming syntax of the cloud service provider enables the cloud solution to be deployed on the cloud infrastructure of the cloud service provider; and
deploy, using the unique programming syntax of the cloud service provider, the cloud solution on the cloud infrastructure of the cloud service provider.

11. The non-transitory, computer-readable storage medium of claim 8, wherein the at least one requirement includes:
an ability of the cloud infrastructure to support a threshold number of simultaneous user traffic volume or a user traffic type;
a threshold provisioning speed of the cloud infrastructure,
wherein provisioning speed is a maximum time for the cloud infrastructure to deploy, initiate, or release resources;
reliability of the cloud infrastructure;
cybersecurity protocols the cloud service provider requires employees to follow;
cybersecurity technology enacted by the cloud service provider;
scalability of the cloud solution on the cloud infrastructure,
wherein scalability of the cloud solution is the ability to increase an amount of computing power, storage, or bandwidth provided to the cloud solution; or
cost to host the cloud solution on the cloud infrastructure of the cloud service provider.

12. The non-transitory, computer-readable storage medium of claim 8, wherein the cloud solution is deployed on the cloud infrastructure of a current cloud service provider, the instructions further cause the system to:
determine an updated list of cloud service providers;
rank the updated list of cloud service providers against the current cloud service provider,
wherein the current cloud service provider ranks above the updated list of cloud service providers;
evaluate, using the LLM, the cloud service provider based on the at least one requirement,
wherein the evaluation determines that redeploying the cloud solution increases the ability of the cloud infrastructure of the cloud service provider to satisfy the at least one requirement;
determine, using the LLM, an updated implementation procedure,
wherein the updated implementation procedure is a process of redeploying the cloud solution on the cloud infrastructure of the cloud service provider; and
redeploy, using the LLM, the cloud solution on the cloud infrastructure of the cloud service provider based on the updated implementation procedure.

13. The non-transitory, computer-readable storage medium of claim 8, wherein the system includes a user interface, the system being further caused to:
calculate a metric score for each cloud service provider on the list of cloud service providers,
wherein the metric score is a calculation that converts the at least one requirement to a single number;
cause display of the metric score and a cost to host the cloud solution; and
cause display of the ranking of cloud service providers.

14. The non-transitory, computer-readable storage medium of claim 8, further caused to:
monitor, using the LLM, the deployed cloud solution for a cybersecurity threat;
detect, based on an anomaly in data generated by the cloud solution, the cybersecurity threat,
wherein the anomaly is caused by at least one of the following: unexpected password resets, user logins from unexpected locations, an increase in unauthorized access attempts beyond a threshold number, or unauthorized changes to a cloud solution system setting;
generate a notification indicating the detection of the cybersecurity threat.

15. A method comprising:
receiving data including a specification for a cloud solution,
wherein the cloud solution includes a computing service implemented on a cloud infrastructure of a cloud service provider,
wherein the specification for the cloud solution indicates a type of cloud solution, at least one requirement of the cloud solution, and executable code used to execute the cloud solution, and
determining, using a large language model (LLM), a list of the cloud infrastructure required to satisfy at least one requirement,
determining, using the LLM, a list of cloud service providers having cloud infrastructure capable of hosting the cloud solution and an ability to satisfy the at least one requirement of the cloud solution,
ranking the cloud service providers based on the capability to host the cloud solution and the ability to satisfy the at least one requirement of the cloud solution;
generating, using the LLM, an implementation procedure based on an Application Programming Interface (API) specification of the cloud service provider and the ranking of the cloud service providers,
wherein the implementation procedure includes a selected cloud service provider and at least one cloud service provider requirement for deploying the cloud solution on the cloud infrastructure of the cloud service provider; and
deploying, using the LLM, the cloud solution on the cloud infrastructure of the cloud service provider in accordance with the implementation procedure,
wherein the LLM converts the executable code of the cloud solution to a programming syntax required by the API specification.

16. The method of claim 15, wherein the cloud solution is migrated from a current cloud service provider to a new cloud service provider, further comprising:
searching for the new cloud service provider;
ranking the new cloud service provider against the current cloud service provider,
wherein the new cloud service provider ranks above the current cloud service provider; and
deploying the cloud solution on the cloud infrastructure of the new cloud service provider,
wherein deploying the cloud solution includes removing the cloud solution from the cloud infrastructure of the current cloud service provider, and
wherein no disruption to the cloud solution occurs during the deployment of the cloud solution on the cloud infrastructure of the new cloud service provider.

17. The method of claim 15, further comprising:
converting, using the LLM, the executable code of the cloud solution to a generic programming code;
saving the generic programming code to a database accessible by the LLM;
converting, using the LLM, the generic programming code to the programming syntax required for the API of the cloud service provider,
wherein each cloud service provider uses a unique programming syntax, and
wherein converting the generic programming code to the programming syntax of the cloud service provider enables the cloud solution to be deployed on the cloud infrastructure of the cloud service provider; and
deploying, using the unique programming syntax of the cloud service provider, the cloud solution on the cloud infrastructure of the cloud service provider.

18. The method of claim 15, wherein the at least one requirement includes:
an ability of the cloud infrastructure to support a threshold number of simultaneous user traffic volume or a user traffic type;
a threshold provisioning speed of the cloud infrastructure,
wherein provisioning speed is a maximum time for the cloud infrastructure to deploy, initiate, or release resources;
reliability of the cloud infrastructure;
cybersecurity protocols the cloud service provider requires employees to follow;
cybersecurity technology enacted by the cloud service provider;
scalability of the cloud solution on the cloud infrastructure,
wherein scalability of the cloud solution is the ability to increase an amount of computing power, storage, or bandwidth provided to the cloud solution; or
cost to host the cloud solution on the cloud infrastructure of the cloud service provider.

19. The method of claim 15, wherein the cloud solution is deployed on the cloud infrastructure of a current cloud service provider, further comprising:
determining, using the LLM, an updated list of cloud service providers;
ranking the updated list of cloud service providers against the current cloud service provider,
wherein the current cloud service provider ranks above the updated list of cloud service providers;
evaluating, using the LLM, the cloud service provider based on the at least one requirement,
wherein the evaluation determines that redeploying the cloud solution increases the ability of the cloud infrastructure of the cloud service provider to satisfy the at least one requirement;
determining, using the LLM, an updated implementation procedure,
wherein the updated implementation procedure is a process of redeploying the cloud solution on the cloud infrastructure of the cloud service provider; and
redeploying, using the LLM, the cloud solution on the cloud infrastructure of the cloud service provider based on the updated implementation procedure.

20. The method of claim 15, further comprising:
calculating a metric score for each cloud service provider on the list of cloud service providers,
wherein the metric score is a calculation that converts the at least one requirement to a single number;
causing display of the metric score on a user interface; and
causing display of the ranking of cloud service providers on the user interface.
